(19) United States
(12) Patent Application Publication
(10) Pub. No.: US 2026/0251584 A1
(43) Pub. Date: Aug. 27, 2026

(54) SMART WEAR SENSOR FOR SLURRY-TRANSPORTING EQUIPMENT AND RELATED METHODS

(71) Applicant: LYNKZ INSTRUMENTS INC., Amos (CA)

(72) Inventors: Xavier BERNARD, Amos (CA); Alexandre BRUNET, Amos (CA)

(21) Appl. No.: 18/874,628

(22) PCT Filed: Jun. 14, 2023
(86) PCT No.: PCT/CA2023/050824

§ 371 Date: Dec. 13, 2024

Related U.S. Application Data
(60) Provisional application No. 63/366,354, filed on Jun. 14, 2022.

(51) Int. Cl. G01N 22/02

(52) U.S. Cl. CPC G01N 22/02

(57) ABSTRACT

There are provided techniques for monitoring a wear level of an inner liner of a slurry-transporting equipment. A system includes at least one sensor mechanically contacting the inner liner of the slurry-transporting equipment, the at least one sensor being adapted to be electromagnetically coupled with a slurry circulating in the slurry-transporting equipment; and monitoring module operatively connected to the at least one sensor, the monitoring module being adapted to receive data generated by the at least one sensor and process the same to obtain an indication that a thickness of the inner liner is below a predetermined threshold. Related methods are also provided.

### TECHNICAL FIELD

The technical field generally relates to techniques for determining or measuring wear of an equipment, and more particularly relates to techniques, including systems and methods, for monitoring a wear level of an inner liner of a slurry-transporting equipment.

### BACKGROUND

Periodic manual inspections of slurry-transporting equipment are a time-consuming process, which can be associated with important costs. Indeed, such inspections typically require a reduction, or a stoppage of the operations being carried by the slurry-transporting equipment. On the one hand, it may be desirable to postpone the manual inspections as much as possible to avoid cases in which the inspections would reveal that the slurry-transport equipment, or portion(s) thereof, is working as expected and that no intervention is needed (i.e., the inspection was not needed). On the other hand, it may be desirable to identify, anticipate and/or predict any future or potential problems that could affect the expected operation of the slurry-transporting equipment before any irreversible damages are made to the slurry-transporting equipment.

Existing solutions are typically associated with several drawbacks, such as lack of precision and/or unreliable measurements. As such, existing techniques are not able to adequately characterize the state of the slurry-transporting equipment or are simply not adapted for the requirements of some industries.

There is thus a need for techniques that address at least some of the challenges presented above.

### SUMMARY

In accordance with one aspect, there is provided a system for monitoring a wear level of an inner liner disposed in an outer shell of a slurry-transporting equipment, the system including:
at least one sensor mechanically contacting the inner liner of the slurry-transporting equipment, the at least one sensor being adapted to be electromagnetically coupled with a slurry circulating in the slurry-transporting equipment; and
a monitoring module operatively connected to the at least one sensor, the monitoring module being adapted to receive data generated by the at least one sensor and process the same to obtain an indication that a thickness of the inner liner is below a predetermined threshold.

In some embodiments, the at least one sensor directly contacts the inner liner of the slurry-transporting equipment.

In some embodiments, the at least one sensor is attached to the outer shell.

In some embodiments, each sensor is flexible and adapted to be bent to conform to at least one of the inner liner and the outer shell.

In some embodiments, the at least one sensor is a plurality of sensors, each sensor being aligned with a corresponding region of high mechanical stress of the slurry-transporting equipment.

In some embodiments, the sensor has a first thickness, and the inner liner has a second thickness, the first thickness being smaller than the second thickness.

In some embodiments, the at least one sensor includes at least one antenna.

In some embodiments, the at least one sensor includes a flexible substrate and an inductive antenna disposed on the flexible substrate.

In some embodiments, the flexible substrate and the inductive antenna each have thermal-resistant properties.

In some embodiments, the thermal-resistant properties include resistance to a temperature up to 550° F.

In some embodiments, the flexible substrate is made from polyimide or a polyimide-based material.

In some embodiments, the at least one sensor is a coil.

In some embodiments, the coil has a substantially rectangular cross-section.

In some embodiments, the at least one sensor includes a printed coil and a sensing circuit, the sensing circuit being configured to drive the printed coil with a driving signal.

In some embodiments, the printed coil is a printed copper coil.

In some embodiments, the driving signal is an alternating current.

In some embodiments, the system further includes at least one additional sensor.

In some embodiments, the at least one additional sensor is selected from the group consisting of: an inertial measurement unit (IMU), an accelerometer, a gyroscope, a magnetometer and a temperature sensor.

In some embodiments, the monitoring module includes a transceiver.

In some embodiments, the at least one sensor is connected to the monitoring module using a wired connection.

In some embodiments, the wired connection includes a pair of wires.

In some embodiments, the wired connection includes a flat cable.

In some embodiments, the monitoring module is further adapted to record and/or save measurements carried out by the at least one sensor, data representative of the measurements carried out by the at least one sensor or signal(s) representative of the measurements carried out by the at least one sensor.

In some embodiments, the monitoring module is configured to send the data or measurements representative of the data to an external interface.

In some embodiments, the monitoring module includes a data storage device for storing past measurements, present or ongoing measurements and/or calibration data.

In some embodiments, the monitoring module is operatively connected to a data storage device or a server for storing past measurements, present or ongoing measurements and/or calibration data.

In some embodiments, the system further includes an alarm, the monitoring module being adapted to send a signal or instructions to the alarm, thereby causing issuance of a notification indicating that the inner liner has to be changed, because the thickness has fallen or is about to fall below the predetermined threshold.

In some embodiments, the alarm is a visible alarm and/or an audible alarm.

In some embodiments, the monitoring module is positioned within the outer shell of the slurry-transporting equipment.

In some embodiments, the monitoring module is positioned outside of the outer shell of the slurry-transporting equipment.

In some embodiments, the at least one sensor, the monitoring module or at least a portion thereof is embedded into epoxy.

In some embodiments, the system further includes a layer of ferrite material disposed between the at least one sensor and an electrically-conductive inner surface of the outer shell of the slurry-transporting equipment.

In some embodiments, the at least one sensor and the monitoring module are integrated into a single unit.

In some embodiments, the system further includes a camera adapted to monitor surroundings of the slurry-transporting equipment, the camera being configured to detect a presence of an object potentially affecting the indication that the thickness of the inner liner is below a predetermined threshold.

In some embodiments, the system further includes a buffer tank containing a buffer solution having properties similar to the slurry circulating into the slurry-transporting equipment; and a buffer sensor adapted to be electromagnetically coupled with the buffer solution, wherein the indication that the thickness of the inner liner is below a predetermined threshold is based on a differential measurement between said at least one sensor and the buffer sensor.

In accordance with another aspect, there is provided a method for monitoring a wear level of an inner liner disposed in an outer shell of a slurry-transporting equipment, the method including:
obtaining data with at least one sensor mechanically contacting the inner liner of the slurry-transporting equipment, the at least one sensor being adapted to be electromagnetically coupled with a slurry circulating in the slurry-transporting equipment;
sending the data generated by the at least one sensor and towards a monitoring module; and
processing the data to obtain an indication that a thickness of the inner liner is below a predetermined threshold.

In accordance with one aspect, there is provided a system for monitoring a wear level of an inner liner disposed in an outer shell of a slurry-transporting equipment, the system including:
an array of antennas mechanically contacting the inner liner of the slurry-transporting equipment, the array of antennas being adapted to send pulses towards a slurry circulating in the slurry-transporting equipment and receive echo signals therefrom; and
a monitoring module operatively connected to the array of antennas, the monitoring module being adapted to receive data generated by the array of antennas, based on the received echo signals, and process the data to obtain an indication that a thickness of the inner liner is below a predetermined threshold.

In some embodiments, each antenna from the array of antennas is a high-frequency antenna having an operation frequency comprised between a range extending from about 20 GHz to about 60 GHz. In some embodiments, in a capacitive mode, the measurement is relatively directional and has a relatively short range (electric field, between about 0.1 MHz and about 10 GHz); in an inductive mode, the measurement is relatively omnidirectional and has a relatively long range (magnetic field, between about 0.1 MHz and about 10 GHz); in a radar mode, the measurement is directional, has a relatively long range and has a relatively high frequency (electromagnetic wave, between about 10 GHz to about 90 GHz). In some embodiments, combinations of these modes are used.

In some embodiments, the array of antennas directly contacts the inner liner of the slurry-transporting equipment.

In some embodiments, the array of antennas is attached to the outer shell.

In some embodiments, each antenna is flexible and adapted to be bent to conform to at least one of the inner liner and the outer shell.

In some embodiments, each antenna is aligned with a corresponding region of high mechanical stress of the slurry-transporting equipment.

In some embodiments, each antenna has a respective thickness, and the inner liner has a second thickness, the respective thickness of each antenna being smaller than the second thickness.

In some embodiments, the system further includes at least one additional sensor.

In some embodiments, the at least one additional sensor is selected from the group consisting of: an inertial measurement unit (IMU), an accelerometer, a gyroscope, a magnetometer, a capacitor, a strain gauge, an optical circuit, and a temperature sensor.

In some embodiments, the monitoring module comprises a transceiver.

In some embodiments, the array of antennas is connected to the monitoring module using a wired connection.

In some embodiments, the wired connection comprises a pair of wires.

In some embodiments, the wired connection comprises a flat cable.

In some embodiments, the monitoring module is further adapted to record and/or save measurements carried out by the array of antennas, data representative of the measurements carried out by the array of antennas or signal(s) representative of the measurements carried out by the array of antennas.

In some embodiments, the monitoring module is configured to send the data or measurements representative of the data to an external interface.

In some embodiments, the monitoring module comprises a data storage device for storing past measurements, present or ongoing measurements and/or calibration data.

In some embodiments, the monitoring module is operatively connected to a data storage device or a server for storing past measurements, present or ongoing measurements and/or calibration data.

In some embodiments, the system further includes an alarm, the monitoring module being adapted to send a signal or instructions to the alarm, thereby causing issuance of a notification indicating that the inner liner has to be changed, because the thickness has fallen or is about to fall below the predetermined threshold.

In some embodiments, the alarm is a visible alarm and/or an audible alarm.

In some embodiments, the monitoring module is positioned within the outer shell of the slurry-transporting equipment.

In some embodiments, the monitoring module is positioned outside of the outer shell of the slurry-transporting equipment.

In some embodiments, the array of antennas, the monitoring module or at least a portion thereof is embedded into epoxy.

In some embodiments, the system further includes a camera adapted to monitor surroundings of the slurry-transporting equipment, the camera being configured to detect a presence of an object potentially affecting the indication that the thickness of the inner liner is below a predetermined threshold.

In some embodiments, the system further includes a buffer tank containing a buffer solution having properties similar to the slurry circulating into the slurry-transporting equipment; and a buffer sensor adapted to be electromagnetically coupled with the buffer solution, wherein the indication that the thickness of the inner liner is below a predetermined threshold is based on a differential measurement between said at least one sensor and the buffer sensor.

In accordance with one aspect, there is provided a method for monitoring a wear level of an inner liner disposed in an outer shell of a slurry-transporting equipment, the method including:
obtaining data with an array of antennas mechanically contacting the inner liner of the slurry-transporting equipment, the array of antennas being adapted to send pulses towards a slurry circulating in the slurry-transporting equipment and receive echo signals therefrom;
sending the data generated by the array of antennas, based on the received echo signals towards a monitoring module; and
processing the data to obtain an indication that a thickness of the inner liner is below a predetermined threshold.

Other features and advantages of the method and system described herein will be better understood upon a reading of preferred embodiments thereof with reference to the appended drawings. Although specific features described in the above summary and in the detailed description below may be described with respect to specific embodiments or aspects, it should be noted that these specific features can be combined with one another unless stated otherwise.

### BRIEF DESCRIPTION OF THE DRAWINGS

FIG. 1 is an illustration of a sensor for a system for monitoring a wear level of an inner liner disposed in an outer shell, in accordance with one embodiment.

FIG. 2 is an illustration of a plurality of sensors for a system for monitoring a wear level of an inner liner disposed in an outer shell, in accordance with one embodiment.

FIG. 3 shows a system for monitoring a wear level of an inner liner disposed in an outer shell, in accordance with one embodiment.

FIG. 4 shows a plurality of sensors operatively connected to a monitoring of a system for monitoring a wear level of an inner liner disposed in an outer shell, in accordance with one embodiment.

FIG. 5 illustrates the working principle of a system for monitoring a wear level of an inner liner disposed in an outer shell.

FIG. 6 shows a network used with a system for monitoring a wear level of an inner liner disposed in an outer shell, in accordance with one embodiment.

FIG. 7 shows simulation results illustrating the electromagnetic field generated by a sensor for a system for monitoring a wear level of an inner liner disposed in an outer shell, in accordance with one embodiment.

FIG. 8 shows simulation results illustrating the electromagnetic field generated by a sensor for a system for monitoring a wear level of an inner liner disposed in an outer shell, in accordance with one embodiment.

FIG. 9 shows a confusion matrix associated with the present techniques.

FIG. 10 shows a system for monitoring a wear level of an inner liner disposed in an outer shell, in accordance with one embodiment.

### DETAILED DESCRIPTION

In the present description, similar features in the drawings have been given similar reference numerals. To avoid cluttering certain figures, some elements may not have been indicated if they were already identified in a preceding figure. It should also be understood that the elements of the drawings are not necessarily depicted to scale, since emphasis is placed on clearly illustrating the elements and structures of the present embodiments. Furthermore, positional descriptors indicating the location and/or orientation of one element with respect to another element are used herein for ease and clarity of description. Unless otherwise indicated, these positional descriptors should be taken in the context of the figures and should not be considered limiting. More particularly, it will be understood that such spatially relative terms are intended to encompass different orientations in the use or operation of the present embodiments, in addition to the orientations exemplified in the figures.

The terms “a”, “an” and “one” are defined herein to mean “at least one”, that is, these terms do not exclude a plural number of items, unless stated otherwise.

Terms such as “substantially”, “generally” and “about”, that modify a value, condition or characteristic of a feature of an exemplary embodiment, should be understood to mean that the value, condition or characteristic is defined within tolerances that are acceptable for the proper operation of this exemplary embodiment for its intended application.

Unless stated otherwise, the terms “connected” and “coupled”, and derivatives and variants thereof, refer herein to any structural or functional connection or coupling, either direct or indirect, between two or more elements. For example, the connection or coupling between the elements may be acoustical, mechanical, optical, electrical, thermal, logical, or any combinations thereof.

Expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present description, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

The term “computer” (or “computing device”) is used to encompass computers, servers and/or specialized electronic devices which receive, process and/or transmit data. Computers are generally part of “systems” and include processing means, such as microcontrollers and/or microprocessors, CPUs or are implemented on FPGAs, as examples only. The processing means are used in combination with storage medium, also referred to as “memory” or “storage means”. Storage medium can store instructions, algorithms, rules and/or data to be processed. Storage medium encompasses volatile or non-volatile/persistent memory, such as registers, cache, RAM, flash memory, ROM, as examples only. The type of memory is, of course, chosen according to the desired use, whether it should retain instructions, or temporarily store, retain or update data. One skilled in the art will therefore understand that each such computer typically includes a processor (or multiple processors) that executes program instructions stored in the memory or other non-transitory computer-readable storage medium or device (e.g., solid state storage devices and/or disk drives. The various functions, modules, services, units or the like disclosed hereinbelow can be embodied in such program instructions, and/or can be implemented in application-specific circuitry (e.g., ASICs or FPGAs) of the computers. Where a computer system includes multiple computers, these devices can, but need not, be co-located. In some embodiments, a computer system can be a cloud-based and/or virtualized (i.e., virtual machine or container) computing system whose processing resources are shared by multiple distinct business entities or other users.

The present description generally relates to non-invasive and non-destructive techniques for sensing, detecting, measuring, tracking and/or monitoring a wear level (sometimes simply referred as “wear”) of an inner liner of a slurry-transporting equipment. Nonlimitative examples of a slurry-transporting equipment include pumps, tubes, pipes, cyclones, hydro-cyclones, and any other equipment or pieces of equipment that are shaped, dimensioned, adapted, sized, and configured for allowing therethrough a passage, circulation, treatment, and/or conditioning of a slurry. The expression “slurry” typically refers to a mixture of solid(s) and liquid(s) (e.g., water). Slurries may include solid(s) or solid portion(s) carried or transported by a carrier or a carrier phase, which may be embodied by a fluid or a mixture of fluids. A nonlimitative example of such solids is mineral(s). In some embodiments, the carrier may be water.

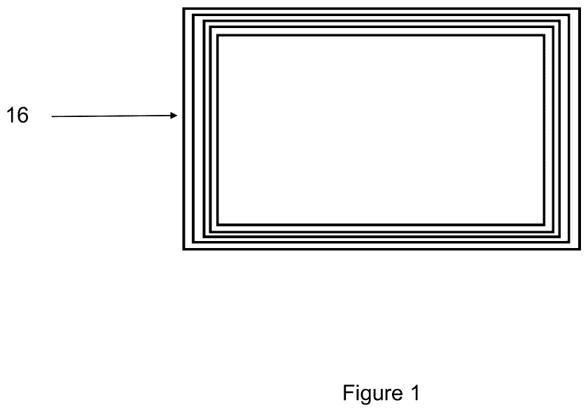

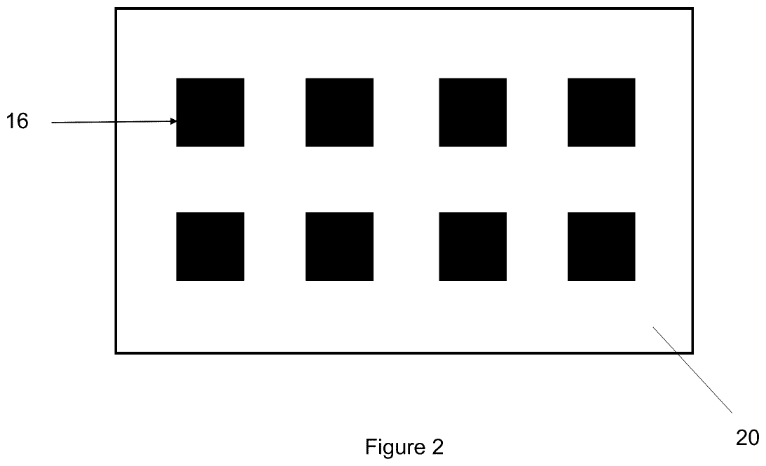

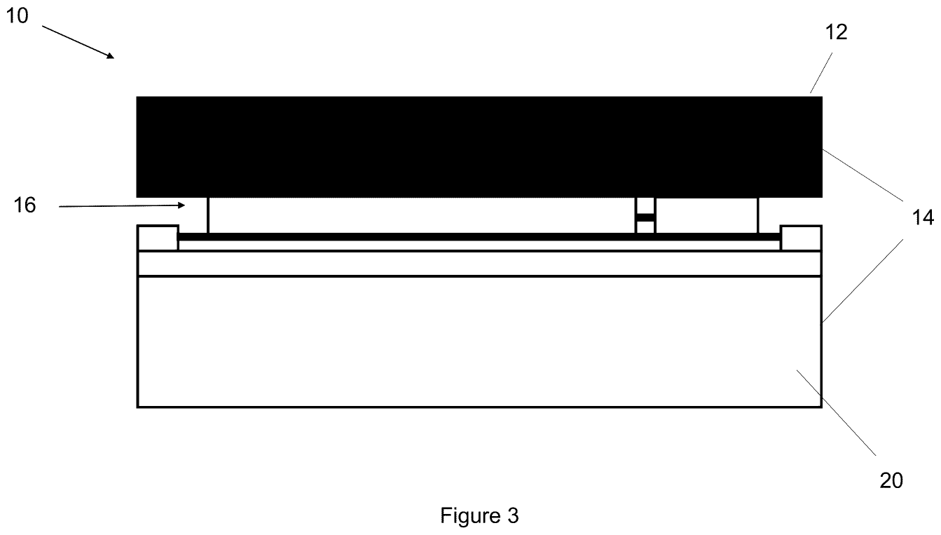

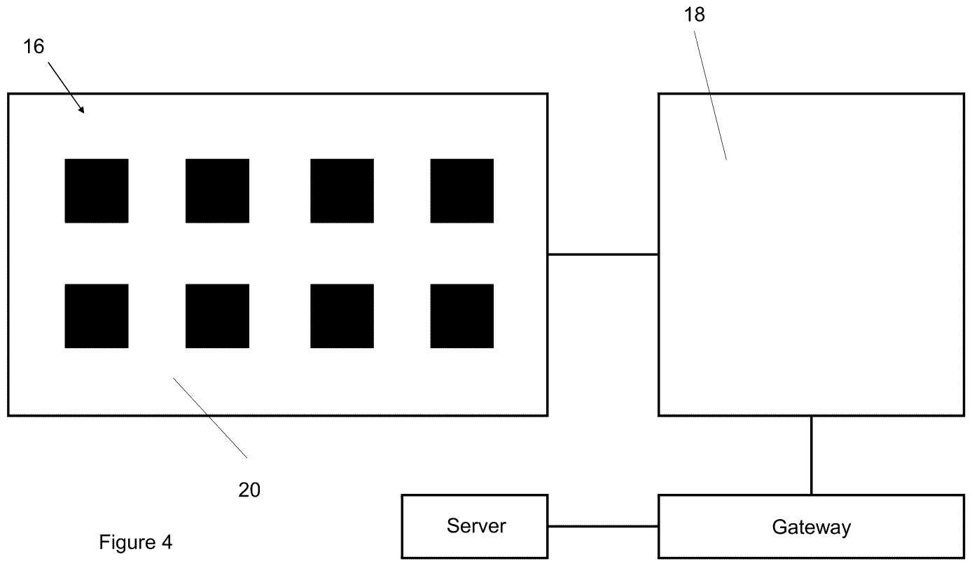

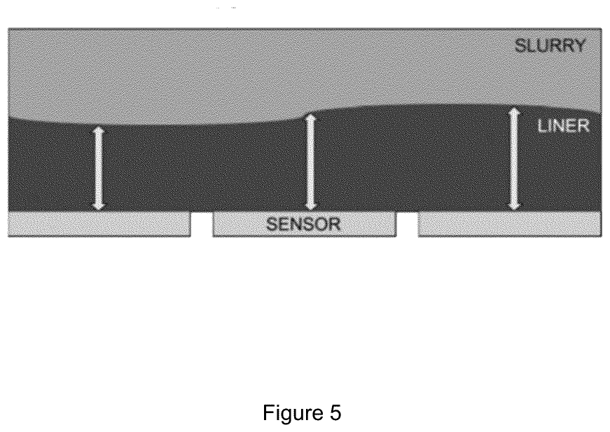

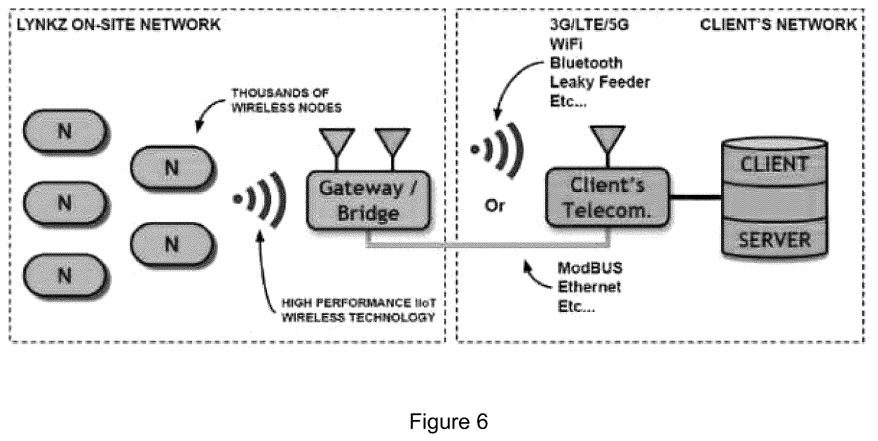

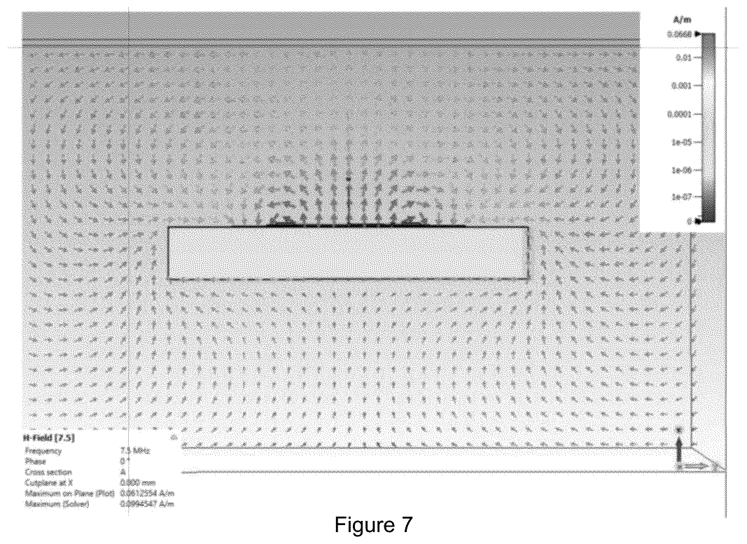

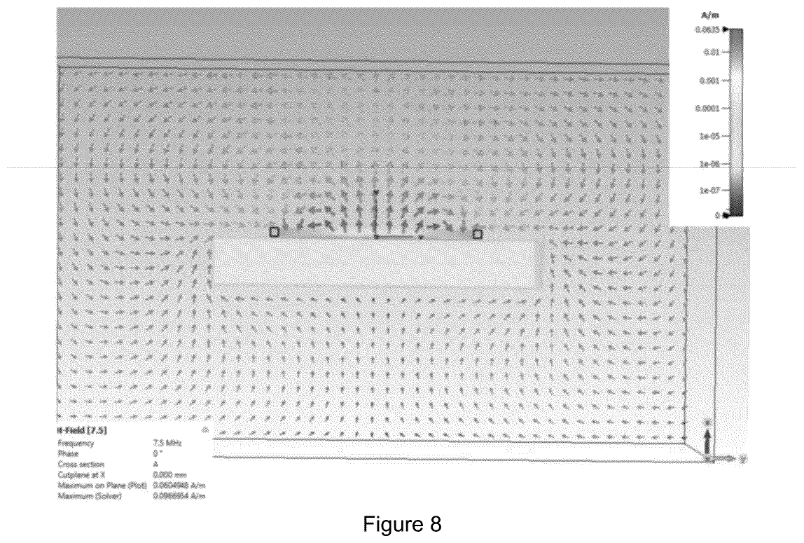

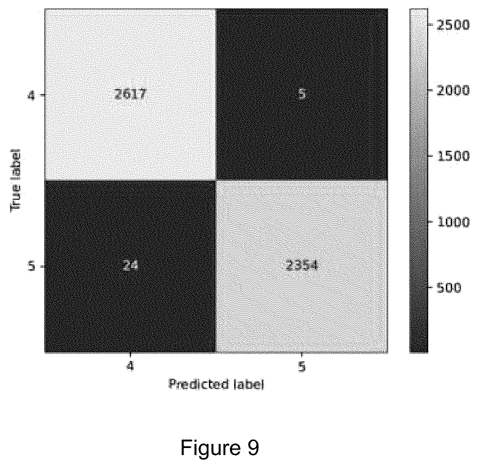

In the mining industry, it is common to use a ball mill in closed circuit with pump(s), cyclone(s), hydro-cyclone(s), and/or other equipment, to grind or blend materials upstream of or prior to a metallurgical process, for example in the context of mineral(s) extraction. Each of the slurry-transporting equipment typically includes an outer shell (sometimes referred to as a “casing”) and an inner liner mounted therein (i.e., inside of the outer shell). The outer shell may be made of a relatively rigid material, such as a metal or a metallic material, while the inner liner may be made of a more resilient material such as, for example, rubber, elastomer, or similar materials, such that the outer shell provides a mechanical support to the inner liner, which has a profile that is complementary to a profile of the outer shell. In operation, the inner liner is typically exposed to relatively harsh mechanical conditions, notably in terms of abrasion, which can cause wear of the inner liner (or at least a portion thereof). This wear is associated with a change or a variation of thickness of the inner liner. More specifically, as the inner liner is worn, its thickness will decrease of be reduced. Below a predetermined threshold, which depends on the slurry and the operating conditions, there is a risk that the inner liner (or the material forming the inner liner) will break or be irreversibly damaged, which can in turn cause irreversible damage to the outer shell or casing, which would render the concerned slurry-transporting equipment useless for any futures uses, meaning that the slurry-transporting equipment would simply have to be replaced. Now turning to FIGS. 1 to 10, embodiments of the techniques, including systems and methods, for monitoring a wear level of an inner liner of a slurry-transporting equipment, will now be presented.

In accordance with one broad aspect, there is provided a system 10 for monitoring a wear level of an inner liner 12 disposed in an outer shell 20 of a slurry-transporting equipment 14. The system 10 includes at least one sensor s (simply referred to as “a sensor” or “the sensor”) and a monitoring module 18, collectively adapted to monitor, in real time or near real time, the wear level of the inner liner 12 without having to stop the operation of the corresponding slurry-transporting equipment 14. In some embodiments, the system 10 is configured periodically measure the wear level of the inner liner 12 according to a predetermined schedule, for example at a predetermined interval or during a predetermined period. These embodiments may be useful in context in which the slurry-transporting equipment 14 is not always in operation, i.e., when the flow of the slurry being transported by the slurry-transporting equipment 14 is not constant (e.g., the flow is intermittent).

The sensor 16 is mechanically engaged to the inner liner 12 of the slurry-transporting equipment 14 and may, in some embodiments, mechanically and directly contact the inner liner 12. The sensor 16 is adapted to be electromagnetically coupled with a slurry circulating in the slurry-transporting equipment 14. In some embodiments, the electromagnetic coupling may be purely inductive, purely electrical, purely magnetic, purely capacitive, or may be any combinations of inductive, electrical, magnetic and capacitive coupling (i.e., the electromagnetic coupling may have one or more components selected from the list presented above).

The sensor 16 is typically relatively flexible, or at least include a flexible portion that allows its positioning in the inner surface of the outer shell 20 or casing. More specifically, the sensor 16 or its corresponding portion has the required flexibility or resiliency to be deformed so as to match the profile of the inner surface of the outer shell 20. As illustrated, the inner surface of the outer shell 20 may include a curved portion, and the sensor 16 (or at least a portion thereof) can conform to this curved profile. The general profile of the sensor 16 is typically complementary to the general profile of the outer shell 20.

The sensor 16 is typically positioned or mounted in regions wherein the mechanical stress associated with the abrasive properties of the slurry is known to be relatively important, or at least significant enough to potentially cause damage to the outer shell 20 of the slurry-transporting equipment 14.

In some embodiments, the sensor 16 may be embodied by a plurality of sensors. The plurality of sensors may be distributed along a given pattern, which may be period, semi-period, or aperiodic. The plurality of sensors may be referred to as an array of sensors.

The thickness of the sensor 16 is relatively small in comparison with the thickness of the inner liner 12 and the thickness of the outer shell 20 or casing, such that the relative positioning of the inner liner 12 and the outer shell 20 is not substantially affected (i.e., the spacing between the inner liner 12 and the outer shell 20 does not significantly increase when a sensor 16 is placed therebetween). The presence of the sensor 16 between the inner liner 12 and the outer shell 20 does not affect the alignment or the positioning of the inner liner 12 in the slurry-transporting equipment 14.

In some embodiments, the sensor 16 may include at least one antenna. In some embodiments, the sensor 16 may include a flexible substrate and an inductive antenna disposed on the flexible substrate. Of note, the inductive antenna may be built on the flexible substrate (e.g., using various deposition and/or etching techniques), or may be transferred onto the flexible substrate after its formation. In some embodiments, the antenna has thermal-resistant properties. In some embodiments, the flexible substrate has thermal-resistant properties. The thermal-resistant properties may include a resistance to relatively high temperature, such as, for example 550° F. In some embodiments, the flexible substrate may be polyimide (e.g., Kapton) or may be a polyimide-based material.

In some embodiments, the inductive antenna may be replaced by a capacitive structure or circuit, or even a strain gauge, or a similar mechanism, to transduce the coating thickness into electromagnetic phenomena.

The sensor 16 may have different geometrical configurations or parameters, which may be associated with corresponding electrical, magnetic, and electromagnetic properties. For example, the sensor 16 may include an electrically-conductive portion arranged to form a coil enclosing an electrically-insulating portion, which may be made from air (i.e., an absence of material). In some embodiments, the coil may have a generally rectangular shape (i.e., the cross-section of the coil resembles the shape of a rectangle). It would have been readily understood that the coil may have other shapes. The dimensions of the coil may vary based on the targeted application or at least one property of the slurry circulating in the slurry-transporting equipment 14, but generally range between about two inches to about five inches, in each direction parallel to the surface of the coil. As previously mentioned, the sensor 16, which may be embodied by a coil, is relatively thin. In some embodiments, the thickness of the coil may range between about 0.01 inch to about 0.02 inch. The relatively small thickness of the sensor 16 is such that its presence does not substantially affect the installation process or the working capacity of the slurry-transporting equipment 14. Of note, the fact that the electrically-conductive portion of the sensor 16 may be arranged to form a coil provides the sensor 16 with inductive properties that can be used to monitor a wear level of the inner liner 12, as will be explained with greater detail below.

The sensor 16 is mounted to the inner surface of the outer shell 20. In some embodiments, the sensor 16 may be fixed, attached or glued to the inner surface of the outer shell 20. When the inner liner 12 is mounted into to outer shell 20, the sensor 16 is disposed or sandwiched between the inner liner 12 and the outer shell 20.

In some embodiments, the sensor 16 includes a printed coil and a sensing circuit. In some embodiments, the printed coil is a printed copper coil. The sensing circuit is configured to drive the printed coil with a driving signal, which may be achieved according to a specific or predetermined pattern. In some embodiments, the sensing circuit is configured to send alternating current (AC) to the printed coil and measure a resonant frequency of the printed coil. The resonant frequency of the printed coil is affected by the environment of the printed coil and is also associated with the inductance of the printed coil. As such, any changes or variations in the electromagnetic environment of the printed coil may be detected through their effect on the electromagnetic properties of the printed coil.

In some embodiments, the system 10 may include other sensors, such as an inertial measurement unit (IMU), an accelerometer, a gyroscope, a magnetometer, a temperature sensor and many others. Additional sensors may be useful when pre-processing or processing the data generated by the sensor, for example during a denoising step or similar signal processing technique(s).

The monitoring module 18 is operatively connected and in data communication with the sensor 16. The monitoring module 18 may be embodied by a transceiver. In some embodiments, the monitoring module 18 is in digital communication with the sensor 16 (e.g., using technologies such as 12C, SPI or UART). The monitoring module 18 is adapted to receive data generated by the sensor 16 or signal(s) representative of the data obtained by the sensor 16, and then process the data or signal(s), in order to determine if or obtain an indication that a thickness of the inner liner 12 is below a predetermined threshold, or otherwise determine if the thickness of the inner liner 12 is substantially the same over time. In some embodiments, the monitoring module 18 may be configured to track the thickness of the inner liner 12 over time, i.e., the monitoring module 18 may continuously determine, monitor or measure the thickness of the inner liner 12. As it will be described later, such monitoring or tracking may be assisted with pre-processing or denoising techniques. In some embodiments, the monitoring module 18 is configured to receive the data or signal collected by the sensor 16 and send the same to an external software, interface or computer for processing or treatment. In some embodiments, the thickness is defined as a dimension extending between two surfaces of the inner liner 12. For instance, the thickness may be defined by a first surface in contact with the slurry circulating in the slurry-transporting equipment and a second surface in contact with the outer shell of the slurry-transporting equipment. In some embodiments, the first surface is substantially parallel to the second surface. In some embodiments, the wear level may be measured by determining a residual percentage of the material initially forming the inner liner 12. For instance, instead of measuring the thickness of the inner liner 12, the monitoring module 18 may be configured to determine a percentage of remaining material forming the inner liner 12 once a slurry has circulated into the slurry-transporting equipment.

The sensor 16 (or each of the sensors when a plurality of sensors is used) may be connected to the monitoring module 18 using a wired connection or similar technologies. In some embodiments, a pair of wires may be used to connect the sensor 16 to the monitoring module 18 or a component thereof. In some embodiments, the wires may be ribbon cables. In some embodiments, the wires may be flat cables. The wires or cable may be inserted in an aperture configured to receive such wires or cables, or through a weep hole.

The monitoring module 18 is adapted to monitor, track, record and/or save the measurements carried out by the sensor, data representative of the measurements carried out by the sensor or signal(s) representative of the measurements carried out by the sensor. The monitoring module 18 is configured to process the data and evaluate whether the thickness of the inner liner has changed or not. In some embodiments, the processing step(s) carried out by the monitoring module 18 may rely on Al or embedded Al. In other embodiments, the processing step(s) may involve the use of machine-learning techniques, models, calibration data, empirical data, theoretical models, and the like.

The monitoring module 18 is typically configured to send the data and/or measurements to any software, server or interface that may be used by the system's user.

In some embodiments, the monitoring module 18 may include a data storage device. Alternatively, the monitoring module 18 may be operatively connected to a data storage device or a server. The data storage device may be used to store past measurements and/or present ongoing measurements, calibration data, and the like. Of note, the data processing can be sequential or successive, continuous, in real time, near real time, or delayed according to a predetermined pattern. The stored information may be logically associated with properties of the slurry, operating condition of the slurry-transporting equipment, and state of the inner liner. This logical association may be provided in the form of a dataset, which may be useful to determine or predict when the inner liner 12 should be replaced. The dataset could also include other relevant information such as, for example and without being limitative, predicted or expected wear of the inner liner 12, date and time of the last maintenance, the occurrence of scheduled events (e.g., maintenance of the system) and/or the occurrence of random events (e.g., malfunctioning of the system or a portion thereof).

In some embodiments, the system 10 may include an alarm, which may include a visible alarm and/or an audible alarm. In these embodiments, the monitoring module 18 may be further adapted to send a signal or instructions to the alarm, which can issue a notification indicating that the inner liner 12 has to be changed, because the thickness has fallen or will soon fall below the predetermined threshold under which damage to the outer shell 20 or casing may occur.

In some embodiments, the monitoring module 18 may be positioned within the outer shell 20 of the slurry-transporting equipment 14. In these embodiments, the monitoring module 18 is sandwiched between the inner liner 12 and the outer shell 20. In other embodiments, the monitoring module 18 may be positioned outside of the outer shell 20 of the slurry-transporting equipment 14.

In the embodiments wherein the sensor 16 includes a printed coil and a sensing circuit, the sensing circuit may either be mounted to the monitoring module 18 or close to the printed coil. Better results are typically obtained in the latter case, as it reduces or minimizes the length of wires or cables required to operate the sensor 16.

The monitoring module 18 may rely on a low-power-wide area network (LPWAN), which may be adapted to use batteries as a source of power. The use of the LPWAN allows operating the monitoring module 18 for a relatively long period (e.g., multiple years), and implement the system such that it covers an indoor plant or an outdoor site using a single gateway. In some embodiments, the gateway may be based on 3G, LTE, 4G or 5G technologies, which may be useful if an independent network, different from the user's network, is required. Of note, the network technologies are selected in terms of range and material penetration, in order to allow integration of the sensor within or inside the slurry-transporting equipment.

In some embodiments, epoxy or similar material may be used to house the electronical components associated with the implementation of the technologies presented above. For example, epoxy provides additional moisture and impact protection. The epoxy could be used as a matrix for various components of the system and could be provided as a block.

The sensor 16 and the monitoring module 18 collectively allow measuring electromagnetic properties of the slurry as it circulates through the slurry-transporting equipment 14. As previously mentioned, the slurry is an electrically conductive solution (i.e., has electromagnetic properties), and so as the inner liner 12 wears out, the slurry is positioned closer and closer to the sensor 16, which allows detecting a variation in the thickness of the inner liner 12, as a change in the relative position between the slurry and the sensor 16 would change or alter the electromagnetic properties or behavior of the sensor 16. It should be noted that the wear level of the inner liner 12 is not necessarily uniform throughout the surface of the inner liner 12, because the slurry may have a different impact on different locations of the inner liner 12.

In some embodiments, the threshold under which the thickness of the inner liner 12 should not fall may be predetermined either by a user or using other methods. This determination may be based on empirical data, theoretical model(s), calibration data, operating conditions of the slurry-transporting equipment, and any combinations thereof. In some embodiments, the threshold may range from about 0.5 inch to about 2 inches. The threshold may be adjusted according to a given application or depending on the slurry circulating within the slurry-transporting equipment 14.

Data acquired by the system 10 may be processed or pre-processed using a denoising algorithm. In this context, the expression “noise” simply refers to variations in the data or measurements that are not associated with a variation of the inner liner thickness, but rather other events, which may sometimes be random. Nonlimitative examples of causes that may be associated with noise or noise signals are a density of the slurry, a composition of the slurry, pressure conditions in the slurry-transporting equipment 14, velocity (flow), temperature conditions of the slurry and/or slurry-transporting equipment 14, and the like. In some embodiments, the denoising techniques or algorithm may be trained using Al techniques. This approach may be supplemented with the help of additional sensors such as pressure, flow, density, temperature, vibrations sensor(s) and the like. The denoising techniques may be useful to obtain a better or more precise estimate of the remaining thickness of the inner liner. In some embodiments, the algorithm is integrated in the monitoring module 18, so that edge computing can take place and make the system more efficient by transmitting pre-processed data instead of whole and bulky data sets.

In some embodiments, the system 10 includes a layer of ferrite material disposed between the sensor and the electrically-conductive inner surface of the outer shell. The presence of the layer of ferrite material prevents or at least reduce the presence or formation of eddy current at the electrically-conductive inner surface of the outer shell 20, which would negatively affect or impact the measurement being made by the sensor 16, as eddy currents would interact with the signal driving the sensor 16 (e.g., the AC driving the printed coil described above).

In some embodiments, the system 10 further includes a camera adapted to monitor surroundings of the slurry-transporting equipment, the camera being configured to detect a presence of an object potentially affecting the indication that the thickness of the inner liner 12 is below a predetermined threshold. In some embodiments, the camera can be used to determine whether the indication that the thickness of the inner liner is a false positive (i.e., the system 10 detects that the inner liner 12 is below the threshold but is in fact not below the threshold) or a measurement representative of the actual state of the inner liner 12. Of note, objects or equipment temporarily or permanently located near the system 10 may affect the readings or measurements carried out by the sensor(s) 16, as their presence may affect the electrical, magnetic or electromagnetic field around or near the slurry-transporting equipment.

In some embodiments, the system 10 further includes a buffer tank containing a buffer solution having properties similar to the slurry circulating into the slurry-transporting equipment; and a buffer sensor adapted to be electromagnetically coupled with the buffer solution, wherein the indication that the thickness of the inner liner is below a predetermined threshold is based on a differential measurement between said at least one sensor and the buffer sensor. In some embodiments, the buffer sensor includes or is covered with a sacrificial liner having properties similar to the inner liner 12, in order to establish a comparison between the inner liner 12 and the sacrificial liner, which may serve as a basis to the differential measurements.

Of note, the computer programs may be implemented in a high-level procedural or object-oriented programming and/or scripting language to communicate with a computer system. The programs could alternatively be implemented in assembly or machine language, if desired. In these implementations, the language may be a compiled or interpreted language. The computer programs are generally stored on a storage media or a device readable by a general or special purpose programmable computer for configuring and operating the computer when the storage media or device is read by the computer to perform the procedures described herein. In some embodiments, the systems may be embedded within an operating system running on the programmable computer.

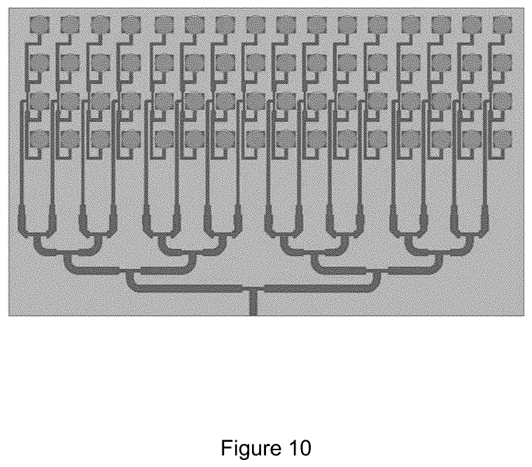

In accordance with another broad aspect, there is provided a system for monitoring a wear level of an inner liner disposed in an outer shell of a slurry-transporting equipment. The system includes an array of antennas (illustrated in FIG. 10) and a monitoring module. The array of antennas mechanically contacts the inner liner of the slurry-transporting equipment and is adapted to send pulses towards a slurry circulating in the slurry-transporting equipment and receive echo signals therefrom. The monitoring module is operatively connected to the array of antennas and is adapted to receive data generated by the array of antennas, based on the received echo signals. The monitoring module is adapted to process the data to obtain an indication that a thickness of the inner liner is below a predetermined threshold.

In some embodiments, each antenna from the array of antennas is a high-frequency antenna having an operation frequency comprised between a range extending from about 20 GHz to about 60 GHZ.

In some embodiments, the array of antennas directly contacts the inner liner of the slurry-transporting equipment.

In some embodiments, the array of antennas is attached to the outer shell.

In some embodiments, each antenna is flexible and adapted to be bent to conform to at least one of the inner liner and the outer shell.

In some embodiments, each antenna is aligned with a corresponding region of high mechanical stress of the slurry-transporting equipment.

In some embodiments, each antenna has a respective thickness, and the inner liner has a second thickness, the respective thickness of each antenna being smaller than the second thickness.

In some embodiments, the system further includes at least one additional sensor.

In some embodiments, the at least one additional sensor is selected from the group consisting of: an inertial measurement unit (IMU), an accelerometer, a gyroscope, a magnetometer, a capacitor, a strain gauge, an optical circuit, and a temperature sensor.

In some embodiments, the monitoring module comprises a transceiver.

In some embodiments, the array of antennas is connected to the monitoring module using a wired connection.

In some embodiments, the wired connection comprises a pair of wires.

In some embodiments, the wired connection comprises a flat cable.

In some embodiments, the monitoring module is further adapted to record and/or save measurements carried out by the array of antennas, data representative of the measurements carried out by the array of antennas or signal(s) representative of the measurements carried out by the array of antennas.

In some embodiments, the monitoring module is configured to send the data or measurements representative of the data to an external interface.

In some embodiments, the monitoring module comprises a data storage device for storing past measurements, present or ongoing measurements and/or calibration data.

In some embodiments, the monitoring module is operatively connected to a data storage device or a server for storing past measurements, present or ongoing measurements and/or calibration data.

In some embodiments, the system further includes an alarm, the monitoring module being adapted to send a signal or instructions to the alarm, thereby causing issuance of a notification indicating that the inner liner has to be changed, because the thickness has fallen or is about to fall below the predetermined threshold.

In some embodiments, the alarm is a visible alarm and/or an audible alarm.

In some embodiments, the monitoring module is positioned within the outer shell of the slurry-transporting equipment.

In some embodiments, the monitoring module is positioned outside of the outer shell of the slurry-transporting equipment.

In some embodiments, the array of antennas, the monitoring module or at least a portion thereof is embedded into epoxy.

In some embodiments, the system further includes a camera adapted to monitor surroundings of the slurry-transporting equipment, the camera being configured to detect a presence of an object potentially affecting the indication that the thickness of the inner liner is below a predetermined threshold.

In some embodiments, the system further includes a buffer tank containing a buffer solution having properties similar to the slurry circulating into the slurry-transporting equipment; and a buffer sensor adapted to be electromagnetically coupled with the buffer solution, wherein the indication that the thickness of the inner liner is below a predetermined threshold is based on a differential measurement between said at least one sensor and the buffer sensor.

In accordance with another broad aspect, there is provided a method for monitoring a wear level of an inner liner of a slurry-transporting equipment. The method includes obtaining data with at least one sensor mechanically contacting the inner liner of the slurry-transporting equipment, the at least one sensor being adapted to be electromagnetically coupled with a slurry circulating in the slurry-transporting equipment. The method also includes sending the data generated by the at least one sensor and towards a monitoring module. The method also includes processing the data to determine if or obtain an indication that a thickness of the inner liner is below a predetermined threshold. In some embodiments, the indication that the thickness of the inner liner is below the predetermined threshold includes carrying out a differential measurement, as it has been explained below.

In an embodiment, steps of the proposed method are implemented as software instructions and algorithms, stored in computer memory and executed by processors. It should be understood that computers are therefore required to implement to proposed system, and to execute the proposed method. In other words, the skilled reader will readily recognize that steps of various above-described methods can be performed by programmed computers. In view of the above, some embodiments are also intended to cover program storage devices, e.g., digital data storage media, which are machine or computer readable and encode machine-executable or computer-executable programs of instructions, wherein said instructions perform some or all of the steps of said above-described methods. The embodiments are also intended to cover computers programmed to perform said steps of the above-described methods.

In accordance with one aspect, there is provided a method for monitoring a wear level of an inner liner disposed in an outer shell of a slurry-transporting equipment, the method including: obtaining data with an array of antennas mechanically contacting the inner liner of the slurry-transporting equipment, the array of antennas being adapted to send pulses towards a slurry circulating in the slurry-transporting equipment and receive echo signals therefrom; sending the data generated by the array of antennas, based on the received echo signals towards a monitoring module; and processing the data to obtain an indication that a thickness of the inner liner is below a predetermined threshold.

In accordance with another aspect of the present description, there is provided a non-transitory computer readable storage medium having stored thereon computer executable instructions that, when executed by a processor, cause the processor to perform the methods that have been previously described. The non-transitory computer storage medium can be integrated to the systems or assemblies that have been described in the present description. The non-transitory computer storage medium could otherwise be operatively connected with the systems or assemblies. In the present description, the terms “computer readable storage medium” and “computer readable memory” are intended to refer to a non-transitory and tangible computer product that can store and communicate executable instructions for the implementation of various steps of the method disclosed herein. The computer readable memory can be any computer data storage device or assembly of such devices, including random-access memory (RAM), dynamic RAM, read-only memory (ROM), magnetic storage devices such as hard disk drives, solid state drives, floppy disks and magnetic tape, optical storage devices such as compact discs (CDs or CDROMs), digital video discs (DVD) and Blu-Ray™ discs; flash drive memory, and/or other non-transitory memory technologies. A plurality of such storage devices may be provided, as can be understood by those skilled in the art. The computer readable memory may be associated with, coupled to, or included in a computer or processor configured to execute instructions contained in a computer program stored in the computer readable memory and relating to various functions associated with the computer.

The techniques having been insofar described are associated with several advantages that will now be presented. The techniques allow obtaining a real-time characterization of the inner liner and real-time indications that there is a risk associated with the operation of a given slurry-transporting equipment. The sensor relies on flexible wireless transmission technologies that are compatible with any existing networks, software or previously existing infrastructures. The sensor has dimensions and mechanical properties that may be adapted or selected to a broad range of possible applications, i.e., the techniques may be customized based on needs dictated by any given situations. The system is easy to install and requires low maintenance. The system is encapsulated, meaning that it is mining proof (it can operate in harsh conditions). The system is also visually discrete, given its relatively small dimensions. These small dimensions also allow installing several systems (sensors and monitoring module(s)) on the same slurry-transporting equipment.

The techniques also allow obtaining improved results in comparison with the results that may be achieved with existing solutions. For example, it is possible to perform thickness measurement with resolution of about 5 mm on 3 inch-thick inner liner. The monitoring module may have a capacity of at least five sensors, which allows operating several sensors using only one monitoring module. As previously mentioned, the system is powered using batteries, and the battery life may extend from at least 6 months to several years. The installation process is also relatively easy and requires about 1 hour maximum.

### Examples

Now that different embodiments of the technology have been described, some nonlimitative examples illustrating potential implementations of the techniques will be presented. It should be noted that these examples serve an illustrative purpose only and should therefore not be considered limitative.

An implementation of a liner wear probe will now be presented. The liner wear probe is a product that may be used in the mining industry to determine the wear level of inner liner inside covering the inner surface of various types of slurry pumps, hydro-cyclones, and many other components. This determination is achieved in real time or near real time. This probe includes at least the two following components: a sensing assembly and a transceiver.

The sensing assembly includes one or more sensors which may be embodied by inductive antennas built on a flexible substrate made of polyimide (or Kapton). This material can withstand temperatures up to 550° F. and is robust enough to be commonly used in the harsh operating conditions of the mining industries.

Instead of a typical serpentine shape, the conductor may be shaped to form a coil, thus giving inductive properties needed to sense its environment of the sensing assembly.

The sensors can be of any dimensions, but the dimensions are typically chosen depending on the application. For rubber liner applications, dimensions from 2 inches to 5 inches in both axes could be used. The thickness of such a stack can go from 0.010 inch to 0.020 inch.

The sensors can be glued on the inner surface of a slurry pump's cover plate just before the liner is inserted into the housing. Their relatively small thickness makes them almost transparent to the usual liner installation process and performance.

It is possible to integrate as many sensors as needed aligned with areas that wear faster than others. For example, an array of them could even give a real time picture of the liner's topology

The sensing assembly may include a printed copper coil and a sensing circuit. The sensing circuit is configured to excite the coil with AC currents and measure the resonant frequency of the coil. This resonant frequency changes depending on the coil's environment and is directly dependent on the inductance of the coil. Other sensors might be integrated in the sensing circuit such as IMUs, accelerometers, gyroscopes, magnetometers and temperature sensors. These extra sensors may help with the denoising of the measurements afterwards.

Of note, the sensing circuit may be located on the transceiver assembly, but better results are achieved when it is located directly on the sensing assembly in order to reduce the measurement cable length.

Since the sensing assembly in applied on a conductive surface, eddy currents can form on the surface, which may impede the AC current excitation of the coil. Ferrite material may be disposed between the sensing assembly and the conductive surface to mitigate the potentially negative effects of the eddy currents. Indeed, the ferrite material may prevent the formation of eddy currents and optimise the coil's excitation, thus the precision of the measurement.

It was observed that the electromagnetic field created around the coil may be conducted by the surface of the conductive surface and man be spread all around the surface (e.g., the pump's frame for example). This spreading causes the coil to be vulnerable to changes in the environment around that conductive surface. Adding a conductive ring around the coil and on the ferrite material may limit the spreading of the electromagnetic field and confines it above the coil, which would make the measurement less vulnerable to the environment of the coil.

Another parameter that affects noise quantity is the cable length between the coil and the sensing circuit. The longer cables are typically associated with more noise in the detected signal(s) or collected data. That is why, in some embodiments the sensing circuit is located directly on the substrate, next to the coil. The sensing circuit may be protected by an epoxy layer for protection during operation.

Now that some examples have been presented, additional details about the sensors and their configuration will be discussed. In some embodiments, a sensor may be embodied by a thin circuit board assembly. Such a sensor may have appropriate structures and circuits relying on an electrical field, a magnetic field and/or an electromagnetic field to measure the configuration and position of a slurry in its environment. It will have been readily understood that the number of sensors may vary. The system may include one or more sensors disposed in the slurry-transporting equipment. Now turning to the configuration of the sensor(s), one or more sensors can be used in any configuration to improve the precision of the measurement and to offer a differential measurement to eliminate or at least reduce surrounding noise. For example, one sensor can be used at the inlet of the pump (or any other slurry-transporting equipment) and another inside the pump (or any other slurry-transporting equipment). The sensor located at or near the inlet is at a constant distance from the slurry, while the other will be at a varying distance from the slurry due to the wear of the inner liner around the sensor. Variations in the composition of the slurry, temperature, density, pressure, flow, and other relevant properties, can therefore be mitigated or even eliminated by making the difference between the two measurements. The effect of wear is therefore based on a differential measurement. When considering the reach of the sensors, the metallic structures and circuits included in the sensor offer different measurement ranges. For example, and without being limitative: in a capacitive mode, the measurement is relatively directional and has a relatively short range (electric field, between about 0.1 MHz and about 10 GHz); in an inductive mode, the measurement is relatively omnidirectional and has a relatively long range (magnetic field, between about 0.1 MHz and about 10 GHz); in a radar mode, the measurement is directional, has a relatively long range and has a relatively high frequency (electromagnetic wave, between about 10 GHz to about 90 GHz). Of course, any combinations of these modes could also be used.

Several alternative embodiments and examples have been described and illustrated herein. The embodiments described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. The present examples and embodiments, therefore, are to be considered in all respects as illustrative and not restrictive. Accordingly, while specific embodiments have been illustrated and described, numerous modifications come to mind without significantly departing from the present disclosure.

1-61. (canceled)

62. A system for monitoring a wear level of an inner liner disposed in an outer shell of a slurry-transporting equipment, the system comprising:
at least one sensor mechanically contacting the inner liner of the slurry-transporting equipment, the at least one sensor being adapted to be electromagnetically coupled with a slurry circulating in the slurry-transporting equipment; and
a monitoring module operatively connected to the at least one sensor, the monitoring module being adapted to receive data generated by the at least one sensor and process the data to obtain an indication that a thickness of the inner liner is below a predetermined threshold.

63. The system of claim 62, wherein the at least one sensor directly contacts the inner liner of the slurry-transporting equipment.

64. The system of claim 62, wherein the at least one sensor is attached to the outer shell.

65. The system of claim 62, wherein each sensor of the at least one sensor is flexible and adapted to be bent to conform to at least one of the inner liner or the outer shell.

66. The system of claim 62, wherein the at least one sensor is a plurality of sensors, each sensor of the plurality of sensors being aligned with a corresponding region of high mechanical stress of the slurry-transporting equipment.

67. The system of claim 62, wherein each sensor of the at least one sensor has a first thickness, and the inner liner has a second thickness, the first thickness being smaller than the second thickness.

68. The system of claim 62, wherein the at least one sensor comprises a flexible substrate and an inductive antenna disposed on the flexible substrate.

69. The system of claim 62, wherein the at least one sensor comprises a printed coil and a sensing circuit, the sensing circuit being configured to drive the printed coil with a driving signal.

70. The system of claim 62, further comprising an alarm, the monitoring module being adapted to send a signal or instructions to the alarm, thereby causing issuance of a notification indicating that the inner liner has to be changed, because the thickness has fallen or is about to fall below the predetermined threshold.

71. The system of claim 62, further comprising a layer of ferrite material disposed between the at least one sensor and an electrically-conductive inner surface of the outer shell of the slurry-transporting equipment.

72. The system of claim 62, further comprising a camera adapted to monitor surroundings of the slurry-transporting equipment, the camera being configured to detect a presence of an object potentially affecting the indication that the thickness of the inner liner is below the predetermined threshold.

73. The system of claim 62, further comprising:
a buffer tank containing a buffer solution having properties similar to the slurry circulating into the slurry-transporting equipment; and
a buffer sensor adapted to be electromagnetically coupled with the buffer solution, wherein the indication that the thickness of the inner liner is below the predetermined threshold is based on a differential measurement between the at least one sensor and the buffer sensor.

74. A method for monitoring a wear level of an inner liner disposed in an outer shell of a slurry-transporting equipment, the method comprising:
obtaining data with at least one sensor mechanically contacting the inner liner of the slurry-transporting equipment, the at least one sensor being adapted to be at least one of electromagnetically or mechanically coupled with a slurry circulating in the slurry-transporting equipment;
sending the data generated by the at least one sensor towards a monitoring module; and
processing the data to obtain an indication that a thickness of the inner liner is below a predetermined threshold.

75. A system for monitoring a wear level of an inner liner disposed in an outer shell of a slurry-transporting equipment, the system comprising:
an array of antennas mechanically contacting the inner liner of the slurry-transporting equipment, the array of antennas being adapted to send pulses towards a slurry circulating in the slurry-transporting equipment and receive echo signals therefrom; and
a monitoring module operatively connected to the array of antennas, the monitoring module being adapted to receive data generated by the array of antennas, based on the echo signals, and process the data to obtain an indication that a thickness of the inner liner is below a predetermined threshold.

76. The system of claim 75, wherein the array of antennas directly contacts the inner liner of the slurry-transporting equipment.

77. The system of claim 75, wherein each antenna of the array of antennas is flexible and adapted to be bent to conform to at least one of the inner liner or the outer shell.

78. The system of claim 75, wherein each antenna of the array of antennas has a respective thickness, and the inner liner has a second thickness, the respective thickness of each antenna being smaller than the second thickness.

79. The system of claim 75, further comprising an alarm, the monitoring module being adapted to send a signal or instructions to the alarm, thereby causing issuance of a notification indicating that the inner liner has to be changed, because the thickness has fallen or is about to fall below the predetermined threshold.

80. The system of claim 75, further comprising a camera adapted to monitor surroundings of the slurry-transporting equipment, the camera being configured to detect a presence of an object potentially affecting the indication that the thickness of the inner liner is below the predetermined threshold.

81. The system of claim 75, further comprising:
a buffer tank containing a buffer solution having properties similar to the slurry circulating into the slurry-transporting equipment; and
a buffer sensor adapted to be electromagnetically coupled with the buffer solution, wherein the indication that the thickness of the inner liner is below the predetermined threshold is based on a differential measurement between the array of antennas and the buffer sensor.
